(19) United States
(12) Patent Application Publication
(10) Pub. No.: US 2021/0017718 A1
(43) Pub. Date: Jan. 21, 2021

(54) DURABLE INORGANIC PARTICLE BOARD AND PREPARATION METHOD AND APPLICATION THEREOF

(71) Applicant: Central South University of Forestry and Technology, Changsha (CN)

(72) Inventors: Xia Zheng, Changsha (CN); Yiqiang Wu, Changsha (CN); Xingong Li, Changsha (CN); Xianjun Li, Changsha (CN); Yan Qing, Changsha (CN); Yingfeng Zuo, Changsha (CN); Ming Liu, Changsha (CN)

(21) Appl. No.: 16/571,596

(22) Filed: Sep. 16, 2019

(30) Foreign Application Priority Data
Jul. 18, 2019 (CN) 201910650020.6

(51) Int. Cl. D21H 27/28; B27N 3/00; B27N 3/08; B27N 3/02

(52) U.S. Cl. CPC D21H 27/28; B27N 3/02; B27N 3/08; B27N 3/002

(57) ABSTRACT

Technical fields of building external wall decoration and outdoor furniture material manufacturing, providing a durable inorganic particle board and a preparation method and an application thereof. The preparation method includes: (1) mixing heat-vulcanized silicone rubber with an organic solvent to obtain a sealant solution; (2) mixing calcium chloride, sodium dodecyl sulfate and water to obtain a curing agent solution; (3) spraying the sealant solution on the surface of a shaving to mix with the curing agent solution, an inorganic adhesive and water to obtain a mixture; (4) sequentially laying and hot-pressing the mixture to obtain a pre-molded material; and (5) sequentially curing and drying the pre-molded material to obtain the durable inorganic particle board. The inorganic particle board prepared by the method of the present invention can be well applied to outdoor decoration and outdoor furniture manufacturing, has good durability and a long service life.

### RELATED APPLICATION

This application claims benefit of priority of China Patent Application No. 201910650020.6, filed Jul. 18, 2019, entitled: DURABLE INORGANIC PARTICLE BOARD AND PREPARATION METHOD AND APPLICATION THEREOF. The above-identified, related application is incorporated herein by reference in its entirety.

### FIELD OF USE

The present invention relates to the technical fields of building external wall decoration and outdoor furniture material manufacturing, in particular to a durable inorganic particle board and a preparation method and an application thereof.

### BACKGROUND OF THE INVENTION

Inorganic particle board is an inorganic artificial board prepared by such processes as mixing and stirring, laying, hot or cold pressing, curing, trimming and sanding, using gypsum, ordinary Portland cement and the like as an inorganic adhesive, and a wood or non-wood shaving (particle) as a reinforcing material. It has excellent properties such as good mechanical strength, waterproofness, heat insulation, fireproofness, and no release of free formaldehyde or other toxic gases, and can be widely used in such fields as decoration and furniture manufacturing.

When the inorganic particle board is used in the fields of outdoor decoration and outdoor furniture manufacturing, etc., the reinforcing component of wood or non-wood shaving in the inorganic particle board is prone to breeding a fungus like a decay fungus after absorbing moisture in a humid environment, thereby decaying and failing to reinforce, resulting in that the strength of the inorganic particle board is significantly reduced and the service life thereof is affected.

### SUMMARY OF THE INVENTION

In view of this, an objective of the present invention is to provide a durable inorganic particle board and a preparation method and an application thereof The preparation method provided by the present invention can significantly prolong the durability and service life of an inorganic particle board, and the inorganic particle board prepared by the method of the present invention can be well applied to the fields of outdoor decoration and outdoor furniture manufacturing.

To achieve the above purpose, the present invention provides the following technical solutions.

The present invention provides a preparation method of a durable inorganic particle board, including the following steps:

(1) mixing heat-vulcanized silicone rubber with an organic solvent to obtain a sealant solution;

(2) mixing calcium chloride, sodium dodecyl sulfate and water to obtain a curing agent solution;

(3) spraying the sealant solution on the surface of a shaving to mix with the curing agent solution, an inorganic adhesive and water to obtain a mixture;

(4) sequentially laying and hot-pressing the mixture to obtain a pre-molded material; and

(5) sequentially curing and drying the pre-molded material to obtain the durable inorganic particle board;

where an execution sequence of the steps (1) and (2) is not limited herein.

Preferably, in the step (1), the organic solvent includes one or more of n-hexane, hexahydrofuran and dioxane; the viscosity of the sealant solution is 150-350 MPa·s.

Preferably, in the step (2), the mass ratio of the calcium chloride, the sodium dodecyl sulfate and the water is (8-10):(1-2):(88-95).

Preferably, in the step (3), the shaving includes a wood shaving and/or a non-wood shaving; the shaving has a length of 10-40 mm, a width of 0.3-0.5 mm, a thickness of 0.1-0.3 mm, and a moisture content of 10%-12%.

Preferably, in the step (3), the heat-vulcanized silicone rubber and the shaving in the sealant solution have a mass ratio of 0.5-1:9-9.5; the shaving, the inorganic adhesive, the curing agent solution and the water have a mass ratio of (20-30):(60-75):(1-2):(30-40); the mass of the shaving is based on an absolute dry weight; the inorganic adhesive includes gypsum and/or Portland cement.

Preferably, in step (4), the thickness of the laying is 40-160 mm; the temperature of the hot-pressing is 100-120° C., the pressure is preferably 3-4 MPa, and the time is 50-80 s/mm.

Preferably, in the step (5), the curing is atmospheric natural curing; the time of the curing is 12-20 d; the temperature of the drying is 80-90° C.; the moisture content of the durable inorganic particle board is 10%-12%.

Preferably, after drying in the step (5), the preparation method further includes performing an edge-aligning and sanding treatment on the dried board.

The present invention further provides a durable inorganic particle board prepared by the above preparation method.

The present invention further provides an application of the above durable inorganic particle board in the fields of outdoor decoration and outdoor furniture manufacturing.

The present invention provides a preparation method of a durable inorganic particle board, including the following steps: (1) mixing heat-vulcanized silicone rubber with an organic solvent to obtain a sealant solution; (2) mixing calcium chloride, sodium dodecyl sulfate and water to obtain a curing agent solution; (3) spraying the sealant solution on the surface of a shaving to mix with the curing agent solution, an inorganic adhesive and water to obtain a mixture; (4) sequentially laying and hot-pressing the mixture to obtain a pre-molded material; and (5) sequentially curing and drying the pre-molded material to obtain the durable inorganic particle board. The present invention sprays the heat-vulcanized silicone rubber on the surface of the shaving; then through the action of a hot-pressing process, the heat-vulcanized silicone rubber is sufficiently vulcanized on the surface of the shaving to form a dense film on the surface of the shaving, so that moisture will not come into contact with the shaving even when the inorganic particle board is used in a humid environment; at the same time, due to the seal of the heat-vulcanized silicone rubber film, the shaving lacks oxygen, and fungi such as decay fungi lose their breeding environment, thereby avoiding the decay of the shaving and significantly prolonging the durability of the inorganic particle board to extend a service life thereof. Therefore, the inorganic particle board prepared by the present invention can be well applied to fields such as outdoor decoration and outdoor furniture manufacturing, and has good durability and a long service life. A result of an embodiment shows that the inorganic particle board prepared by the method of the present invention can significantly prolong the durability of the inorganic particle board compared with an ordinary inorganic particle board which is not subjected to a sealing treatment.

### DETAILED DESCRIPTION

The present invention provides a preparation method of a durable inorganic particle board, including the following steps:

(1) mix heat-vulcanized silicone rubber with an organic solvent to obtain a sealant solution;

(2) mix calcium chloride, sodium dodecyl sulfate and water to obtain a curing agent solution;

(3) spray the sealant solution on the surface of a shaving to mix with the curing agent solution, an inorganic adhesive and water to obtain a mixture;

(4) sequentially lay and hot-press the mixture to obtain a pre-molded material; and

(5) sequentially cure and dry the pre-molded material to obtain the durable inorganic particle board.

An execution sequence of the steps (1) and (2) is not limited herein.

The present invention mixes the heat-vulcanized silicone rubber with the organic solvent to obtain the sealant solution. The present invention has no particular requirement on the specific type and source of the heat-vulcanized silicone rubber, and heat-vulcanized silicone rubber well known in the art can be used, specifically, methyl silicone rubber or methyl vinyl silicone rubber. In the present invention, the heat-vulcanized silicone rubber is a sealant. In the present invention, the organic solvent preferably includes one or more of n-hexane, hexahydrofuran and dioxane, and more preferably n-hexane; the viscosity of the sealant solution is preferably 150-350 MPa·s, and more preferably 200-300 MPa·s. The present invention has no particular requirement on the method of mixing the heat-vulcanized silicone rubber with the organic solvent, and a mixing method well known in the art can be used to ensure that the heat-vulcanized silicone rubber is uniformly mixed with the organic solvent, specifically, for example, stirring and mixing.

The present invention mixes the calcium chloride, the sodium dodecyl sulfate and the water to obtain the curing agent solution. In the present invention, the mass ratio of the calcium chloride, the sodium dodecyl sulfate and the water is preferably (8-10):(1-2):(88-95), and more preferably 10:2:88. The present invention has no particular requirement on the source of the calcium chloride and the sodium dodecyl sulfate, and those available in the market can be used. The present invention has no particular requirement on the order of mixing the calcium chloride, the sodium dodecyl sulfate and the water, and the three may be mixed in any order. The present invention has no particular requirement on the method of mixing, and a method well known in the art can be used to ensure that the calcium chloride, the sodium dodecyl sulfate and the water are uniformly mixed. In the present invention, the calcium chloride and the sodium dodecyl sulfate jointly serve as a curing agent for promoting the curing of the inorganic adhesive.

After obtaining the sealant solution and the curing agent solution, the present invention sprays the sealant solution on the surface of the shaving to mix with the curing agent solution, the inorganic adhesive and the water to obtain the mixture. In the present invention, the shaving preferably includes a wood shaving and/or a non-wood shaving; the shaving has a length of preferably 10-40 mm, more preferably 20-30 mm, and a width of preferably 0.3-0.5 mm, more preferably 0.4 mm, and a thickness of preferably 0.1-0.3 mm, more preferably 0.2 mm. In the present invention, the shaving is preferably machined from a wood or non-wood material, specifically, wood, bamboo or agricultural straw such as cotton straw. The present invention has no particular requirement on the method of the machining, and a machining method well known in the art can be used to ensure that the length, width and thickness of the obtained shaving are satisfactory. In the present invention, the shaving has a moisture content of preferably 10%-12%. In a specific embodiment of the present invention, if the moisture content of the shaving does not meet the requirement, the shaving is preferably dried to have a moisture content of 10%-12% before the sealant solution is spayed. The present invention has no particular requirement on the method of the drying, and a method well known in the art can be used to dry the shaving to the satisfactory water content.

In the present invention, the heat-vulcanized silicone rubber and the shaving in the sealant solution have a mass ratio of preferably 0.5-1:9-9.5, more preferably 0.8:9.3; the mass of the shaving is based on an absolute dry weight. In the present invention, in order to uniformly spray the sealant solution on the surface of the shaving, the present invention preferably sprays under a stirring condition, specifically, the shaving is fed to a mechanical stirrer to start stirring, and the sealant solution is sprayed to the shaving under stirring, while stirring while spraying; the spraying preferably forms the sealant solution into a mist. In the present invention, as the organic solvent in the sealant solution is volatile, the present invention further preferably connects a draft fan above the mechanical stirrer; an outlet of the draft fan is connected to a condenser, which recovers the organic solvent for reuse after the organic solvent is volatilized. The present invention realizes the sealing treatment of the shaving by spraying the sealant solution on the surface of the shaving, so that the sealant (i.e. the heat-vulcanized silicone rubber) forms a wrap film on the surface of the shaving.

After the sealant solution is sprayed on the surface of the shaving, the shaving is mixed with the curing agent solution, the inorganic adhesive and the water. In the present invention, the shaving, the inorganic adhesive, the curing agent solution and the water have a mass ratio of preferably (20-30):(60-75):(1-2):(30-40), more preferably (25-28):(65-70):(1.2-1.8):(34-36); the mass of the shaving is based on an absolute dry weight. In the present invention, the inorganic adhesive preferably includes gypsum and/or Portland cement. The present invention has no particular requirements on the gypsum and the Portland cement, and those well known in the art can be used. The present invention preferably mixes under a stirring condition, specifically, the shaving sprayed with the sealant solution, the inorganic adhesive, the curing agent solution and the water are fed to the stirrer to be stirred and mixed. The present invention has no particular requirement on the time and rotation speed of the stirring, so long as the various components can be uniformly mixed.

After obtaining the mixture, the present invention sequentially lays and hot-presses the mixture to obtain the pre-molded material. In the present invention, the thickness of the laying is preferably 40-160 mm, more preferably 80-120 mm; the laying is preferably performed by a mechanical laying machine. The present invention has no particular requirement on the mechanical laying machine, and a mechanical laying machine well known in the art can be used. After the laying, the mixture forms an inorganic particle board slab. In the present invention, the temperature of the hot-pressing is preferably 100-120° C., more preferably 110° C., the pressure is preferably 3-4 MPa, more preferably 3.5 MPa, and the time is preferably 50-80 s/mm, more preferably 70 s/mm. In the present invention, the hot-pressing is preferably performed by a hot press. The present invention has no particular requirement on the hot press, and a hot press well known in the art can be used. After the hot-pressing, the inorganic particle board slab forms a pre-molded material.

After obtaining the pre-molded material, the present invention sequentially cures and dries the pre-molded material to obtain the durable inorganic particle board for outdoor use. In the present invention, the curing is preferably atmospheric natural curing; the time of the curing is preferably 12-20 d, more preferably 14-18 d; the curing is preferably performed in a curing room. In the present invention, the temperature of the drying is preferably 80-90° C., more preferably 85° C.; the moisture content of the durable inorganic particle board obtained after the drying is preferably 10%-12%, which means that the time of the drying is appropriate when the moisture content of the obtained board is reduced to the required range. In the present invention, the drying is preferably performed in a drying kiln.

After the drying, the present invention further performs an edge-aligning and sanding treatment on the dried board. The present invention has no particular requirement on the method of the edge-aligning and sanding treatment, and a method well known in the art can be used. Specifically, the dried board is fed to a vertical and horizontal edger for edge aligning, and then fed to a wide belt sander for surface sanding, to obtain the durable inorganic particle board after the edge-aligning and sanding treatment,

The present invention provides a preparation method of the above durable type inorganic particle board. The present invention sprays the heat-vulcanized silicone rubber on the surface of the shaving; then through the action of a hot-pressing process, the heat-vulcanized silicone rubber is sufficiently vulcanized on the surface of the shaving to form a dense film on the surface of the shaving, so that moisture will not come into contact with the shaving even when the inorganic particle board is used in a humid environment; at the same time, due to the seal of the heat-vulcanized silicone rubber film, the shaving is anoxic, and fungi such as decay fungi lose their breeding environment, thereby protecting the shaving from decaying and significantly prolonging the durability of the inorganic particle board, which helps to extend the service life of the inorganic particle board.

The present invention further provides a durable inorganic particle board prepared by the above method and an application of the durable inorganic particle board in the fields of outdoor decoration and outdoor furniture manufacturing. The inorganic particle board provided by the present invention can be well applied to such fields as outdoor decoration and outdoor furniture manufacturing, and has good durability and a long service life.

The following describes the durable inorganic particle board and the preparation method and the application thereof in detail below with reference to embodiments, but the embodiments may not be construed as a limitation to the claimed scope of the present invention.

### Embodiment 1

(1) Poplar wood is machined into a poplar shaving having a length of 30 mm, a width of 0.5 mm, and a thickness of 0.2 mm.

(2) Heat-vulcanized silicone rubber and n-hexane are mixed to prepare a silicone rubber solution having a viscosity of 250 MPa·s, namely, a sealant solution.

(3) Calcium chloride, sodium dodecyl sulfate and tap water are mixed in a ratio of 10:2:88 to form a solution, namely, a curing agent solution.

(4) The poplar shaving is dried to a moisture content of 10%, and then fed to a mechanical stirrer to start stirring; a mist-like sealant solution having a viscosity of 250 MPa·s is sprayed on the poplar shaving in the stirrer; the mist-like sealant solution is sprayed for 8 min while the polar shaving is stirred, so that the sealant solution is uniformly sprayed on the surface of the shaving, where the heat-vulcanized silicone rubber and the poplar shaving (absolute dry weight) in the sealant solution have a mass ratio of 1:19; a draft fan is connected above the stirrer, and an outlet of the draft fan is connected to a condenser; the n-hexane is volatile, and after the n-hexane is volatilized, the condenser condenses and recovers the solvent for reuse.

(5) The sealed poplar shaving, Poland cement 325, tap water and the curing agent solution are fed to the stirrer to be stirred uniformly, where the poplar shaving (absolute dry weight) accounts for 27 parts by mass, the ordinary Portland cement accounts for 70 parts by mass, the tap water accounts for 35 parts by mass, and the curing agent solution accounts for 1 part by mass.

(6) The uniformly stirred mixture is fed to a mechanical laying machine to form a 120 mm thick inorganic particle board slab on a backing plate, and the inorganic particle board slab is fed to a hot press to be hot-pressed and molded into a 40 mm thick inorganic particle board, where the temperature of the hot-pressing is 110° C., the pressure of the hot-pressing is 3.5 MPa, and the time of the hot-pressing is 2,400 s.

(7) A semi-finished product molded by the hot-pressing is separated from the backing plate, stacked, and fed to a curing room for natural curing for 20 d.

(8) The naturally dried inorganic particle board is fed to a drying kiln and dried at a temperature of 80° C. to a moisture content of about 10%.

(9) Edge-aligning and sanding: the dried board is fed to a vertical and horizontal edger for vertical and horizontal trimming, and then fed to a wide belt sander for surface sanding, to finally obtain a finished poplar inorganic particle board.

### COMPARATIVE EXAMPLE 1

Steps (2) and (4) of Embodiment 1 are omitted, that is, the poplar shaving is not subjected to the sealing treatment, and the rest is the same as those of Embodiment 1; a finally obtained poplar inorganic particle board is an ordinary inorganic particle board.

The poplar inorganic particle boards obtained in Embodiment 1 and Comparative Example 1 are subjected to an outdoor natural aging test (refer to the international standard ISO 16053-2010), and the results are shown in Table 1:

TABLE 1
Comparison of natural aging test results of poplar inorganic
particle boards of Embodiment 1 and Comparative Example 1

| | Thickness | | | Static bending | | | Internal bond | | |
|---|---|---|---|---|---|---|---|---|---|
| | swelling | | | strength reduction | | | strength reduction | | |
| | rate (%) | | | rate (%) | | | rate (%) | | |
| | 1 | 2 | 3 | 1 | 2 | 3 | 1 | 2 | 3 |
| | year | years | years | year | years | years | year | years | years |
| Compara- | 0.7 | 1.2 | 1.44 | 2.6 | 3.0 | 6.4 | 1.0 | 1.33 | 2.6 |
| tive | | | | | | | | | |
| Example 1 | | | | | | | | | |
| Embodi- | 0.2 | 0.25 | 0.4 | 0.32 | 0.37 | 0.49 | 0.05 | 0.18 | 0.32 |
| ment 1 | | | | | | | | | |

### Embodiment 2

(1) A bamboo is machined into a bamboo shaving having a length of 25 mm, a width of 0.4 mm, and a thickness of 0.3 mm.

(2) Heat-vulcanized silicone rubber and n-hexane are mixed to prepare a silicone rubber solution having a viscosity of 200 MPa·s, namely, a sealant solution.

(3) Calcium chloride, sodium dodecyl sulfate and tap water are mixed in a ratio of 10:2:88 to form a solution, namely, a curing agent solution.

(4) The bamboo shaving is dried to a moisture content of 10%, and then fed to a mechanical stirrer to start stirring; a mist-like sealant solution having a viscosity of 200 MPa·s is sprayed on the bamboo shaving in the stirrer; the mist-like sealant solution is sprayed for 6 min while the bamboo shaving is stirred, so that the sealant solution is uniformly sprayed on the surface of the bamboo shaving, where the heat-vulcanized silicone rubber and the bamboo shaving (absolute dry weight) in the sealant solution have a mass ratio of 1:18; a draft fan is connected above the stirrer, and an outlet of the draft fan is connected to a condenser; the n-hexane is volatile, and after the n-hexane is volatilized, the condenser condenses and recovers the solvent for reuse.

(5) The sealed bamboo shaving, Poland cement 425, tap water and the curing agent solution are fed to the stirrer to be stirred uniformly, where the bamboo shaving (absolute dry weight) accounts for 25 parts by mass, the ordinary Portland cement accounts for 68 parts by mass, the tap water accounts for 34 parts by mass, and the curing agent solution accounts for 1.2 parts by mass.

(6) The uniformly stirred mixture is fed to a mechanical laying machine to form a 90 mm thick inorganic particle board slab on a backing plate, and the inorganic particle board slab is fed to a hot press to be hot-pressed and molded into a 30 mm thick inorganic particle board, where the temperature of the hot-pressing is 115° C., the pressure of the hot-pressing is 4.0 MPa, and the time of the hot-pressing is 1,800 s.

(7) A semi-finished product molded by the hot-pressing is separated from the backing plate, stacked, and fed to a curing room for natural curing for 20 d.

(8) The naturally dried inorganic particle board is fed to a drying kiln and dried at a temperature of 80° C. to a moisture content of about 10%.

(9) Edge-aligning and sanding: the dried board is fed to a vertical and horizontal edger for vertical and horizontal trimming, and then fed to a wide belt sander for surface sanding, to finally obtain a finished bamboo inorganic particle board.

### COMPARATIVE EXAMPLE 2

Steps (2) and (4) of Embodiment 2 are omitted, that is, the bamboo shaving is not subjected to the sealing treatment, and the rest is the same as those of Embodiment 2; a finally obtained bamboo inorganic particle board is an ordinary inorganic particle board.

The bamboo inorganic particle boards obtained in Embodiment 2 and Comparative Example 2 are subjected to an outdoor natural aging test, and the results are shown in Table 2:

TABLE 2
Comparison of natural aging test results of bamboo inorganic
particle boards of Embodiment 2 and Comparative Example 2

| | | | | Static bending | | | Internal bond | | |
|---|---|---|---|---|---|---|---|---|---|
| | Thickness | | | strength reduction | | | strength reduction | | |
| | swelling rate (%) | | | rate (%) | | | rate (%) | | |
| | 1 | 2 | 3 | 1 | 2 | 3 | 1 | 2 | 3 |
| | year | years | years | year | years | years | year | years | years |
| Compara- | 0.77 | 1.25 | 1.6 | 3.1 | 3.6 | 8.0 | 1.1 | 1.43 | 2.1 |
| tive | | | | | | | | | |
| Example 2 | | | | | | | | | |
| Embodi- | 0.24 | 0.3 | 0.55 | 0.37 | 0.42 | 0.62 | 0.09 | 0.3 | 0.41 |
| ment 2 | | | | | | | | | |

### Embodiment 3

(1) Cotton straw is machined into a cotton straw shaving having a length of 30 mm, a width of 0.4 mm, and a thickness of 0.3 mm.

(2) Heat-vulcanized silicone rubber and n-hexane are mixed to prepare a silicone rubber solution having a viscosity of 300 MPa·s, namely, a sealant solution.

(3) Calcium chloride, sodium dodecyl sulfate and tap water are mixed in a ratio of 10:2:88 to form a solution, namely, a curing agent solution.

(4) The cotton straw shaving is dried to a moisture content of 10%, and then fed to a mechanical stirrer to start stirring; a mist-like sealant solution having a viscosity of 300 MPa·s is sprayed on the cotton straw shaving in the stirrer; the mist-like sealant solution is sprayed for 8 min while the cotton straw shaving is stirred, so that the sealant solution is uniformly sprayed on the surface of the cotton straw shaving, where the heat-vulcanized silicone rubber and the cotton straw shaving (absolute dry weight) in the sealant solution have a mass ratio of 1:18.5; a draft fan is connected above the stirrer, and an outlet of the draft fan is connected to a condenser; the n-hexane is volatile, and after the n-hexane is volatilized, the condenser condenses and recovers the solvent for reuse.

(5) The sealed cotton straw shaving, Poland cement 425, tap water and the curing agent solution are fed to the stirrer to be stirred uniformly, where the cotton straw shaving (absolute dry weight) accounts for 30 parts by mass, the ordinary Portland cement accounts for 70 parts by mass, the tap water accounts for 35 parts by mass, and the curing agent solution accounts for 1.5 parts by mass.

(6) The uniformly stirred mixture is fed to a mechanical laying machine to form a 60 mm thick inorganic particle board slab on a backing plate, and the inorganic particle board slab is fed to a hot press to be hot-pressed and molded into a 20 mm thick inorganic particle board, where the temperature of the hot-pressing is 120° C., the pressure of the hot-pressing is 3.0 MPa, and the time of the hot-pressing is 1,400 s.

(7) A semi-finished product molded by the hot-pressing is separated from the backing plate, stacked, and fed to a curing room for natural curing for 20 d.

(8) The naturally dried inorganic particle board is fed to a drying kiln and dried at a temperature of 75° C. to a moisture content of about 10%.

(9) Edge-aligning and sanding: the dried board is fed to a vertical and horizontal edger for vertical and horizontal trimming, and then fed to a wide belt sander for surface sanding, to finally obtain a finished bamboo inorganic particle board

### COMPARATIVE EXAMPLE 3

Steps (2) and (4) of Embodiment 3 are omitted, that is, the cotton straw shaving is not subjected to the sealing treatment, and the rest is the same as those of Embodiment 3; a finally obtained cotton straw inorganic particle board is an ordinary inorganic particle board.

The cotton straw inorganic particle boards obtained in Embodiment 3 and Comparative Example 3 are subjected to an outdoor natural aging test, and the results are shown in Table 3:

TABLE 3
Comparison of natural aging test results of cotton straw inorganic
particle boards of Embodiment 3 and Comparative Example 3

| | | | | Static bending | | | Internal bond | | |
|---|---|---|---|---|---|---|---|---|---|
| | Thickness | | | strength reduction | | | strength reduction | | |
| | swelling rate (%) | | | rate (%) | | | rate (%) | | |
| | 1 | 2 | 3 | 1 | 2 | 3 | 1 | 2 | 3 |
| | year | years | years | year | years | years | year | years | years |
| Compara- | 0.8 | 1.23 | 1.5 | 2.5 | 3.1 | 7.4 | 1.1 | 1.43 | 2.1 |
| tive | | | | | | | | | |
| Example 3 | | | | | | | | | |
| Embodi- | 0.2 | 0.27 | 0.45 | 0.3 | 0.33 | 0.56 | 0 | 0.24 | 0.37 |
| ment 3 | | | | | | | | | |

It can be seen from the above embodiments that, compared with the ordinary inorganic particle boards which are not subjected to the sealing treatment, the durability of the inorganic particle boards prepared in Embodiments 1-3 can be significantly prolonged, helping to extend the service life thereof; in other words, the inorganic particle boards prepared in Embodiments 1-3 are all durable inorganic particle boards. Therefore, the inorganic particle boards prepared by the present invention can be well applied to such fields as outdoor decoration and outdoor furniture manufacturing, and has good durability and a long service life.

The foregoing descriptions are only preferred implementation manners of the present invention. It should be noted that for a person of ordinary skill in the art, several improvements and modifications may further be made without departing from the principle of the present invention. These improvements and modifications should also be deemed as falling within the protection scope of the present invention.

What is claimed is:

1. A preparation method of a durable inorganic particle board, comprising the following steps:
(1) mixing heat-vulcanized silicone rubber with an organic solvent to obtain a sealant solution;
(2) mixing calcium chloride, sodium dodecyl sulfate and water to obtain a curing agent solution;
(3) spraying the sealant solution on the surface of a shaving to mix with the curing agent solution, an inorganic adhesive and water to obtain a mixture;
(4) sequentially laying and hot-pressing the mixture to obtain a pre-molded material; and
(5) sequentially curing and drying the pre-molded material to obtain the durable inorganic particle board;
wherein an execution sequence of the steps (1) and (2) is not limited herein.

2. The preparation method according to claim 1, wherein in the step (1), the organic solvent comprises one or more of n-hexane, hexahydrofuran and dioxane; the viscosity of the sealant solution is 150-350 MPa·s.

3. The preparation method according to claim 1, wherein in the step (2), the mass ratio of the calcium chloride, the sodium dodecyl sulfate and the water is (8-10):(1-2):(88-95).

4. The preparation method according to claim 1, wherein in the step (3), the shaving comprises a wood shaving and/or a non-wood shaving; the shaving has a length of 10-40 mm, a width of 0.3-0.5 mm, a thickness of 0.1-0.3 mm, and a moisture content of 10%-12%.

5. The preparation method according to claim 1, wherein in the step (3), the heat-vulcanized silicone rubber and the shaving in the sealant solution have a mass ratio of 0.5-1:9-9.5; the shaving, the inorganic adhesive, the curing agent solution and the water have a mass ratio of (20-30):(60-75):(1-2):(30-40); the mass of the shaving is based on an absolute dry weight; the inorganic adhesive comprises gypsum and/or Portland cement.

6. The preparation method according to claim 4, wherein in the step (3), the heat-vulcanized silicone rubber and the shaving in the sealant solution have a mass ratio of 0.5-1:9-9.5; the shaving, the inorganic adhesive, the curing agent solution and the water have a mass ratio of (20-30):(60-75):(1-2):(30-40); the mass of the shaving is based on an absolute dry weight; the inorganic adhesive comprises gypsum and/or Portland cement.

7. The preparation method according to claim 1, wherein in step (4), the thickness of the laying is40-160 mm; the temperature of the hot-pressing is 100-120° C., the pressure is preferably 3-4 MPa, and the time is 50-80 s/mm.

8. The preparation method according to claim 1, wherein in the step (5), the curing is atmospheric natural curing; the time of the curing is 12-20 d; the temperature of the drying is 80-90° C.; the moisture content of the durable inorganic particle board is 10%-12%.

9. The preparation method according to claim 1, after drying in the step (5), further comprising performing an edge-aligning and sanding treatment on the dried board.

10. The preparation method according to claim 8, after drying in the step (5), further comprising performing an edge-aligning and sanding treatment on the dried board.

11. A durable inorganic particle board, prepared by the preparation method according to claim 1.

12. A durable inorganic particle board, prepared by the preparation method according to claim 2.

13. A durable inorganic particle board, prepared by the preparation method according to claim 3.

14. A durable inorganic particle board, prepared by the preparation method according to claim 4.

15. A durable inorganic particle board, prepared by the preparation method according to claim 5.

16. A durable inorganic particle board, prepared by the preparation method according to claim 6.

17. A durable inorganic particle board, prepared by the preparation method according to claim 7.

18. A durable inorganic particle board, prepared by the preparation method according to claim 8.

19. A durable inorganic particle board, prepared by the preparation method according to claim 9.

20. An application of the durable inorganic particle board according to claim 11 in the fields of outdoor decoration and outdoor furniture manufacturing.
